(19) United States
(12) Patent Application Publication
(10) Pub. No.: US 2007/0208612 A1
(43) Pub. Date: Sep. 6, 2007

(54) Method and System for Detecting and Reporting Sales Trends

(76) Inventor: Paul V. Storm, Dalworthington Gardens, TX (US)

Correspondence Address: STORM LLP, BANK OF AMERICA PLAZA, 901 MAIN STREET, SUITE 7100, DALLAS, TX, 75202, US

(21) Appl. No.: 11/680,825

(22) Filed: Mar. 1, 2007

Related U.S. Application Data
(60) Provisional application No. 60/777,814, filed on Mar. 1, 2006.

(51) Int. Cl. G07G 1/00

(52) U.S. Cl. 705/10

(57) ABSTRACT

Traditionally, fads, crazes, and sudden sales trends have tended to catch suppliers and retailers off-guard. Thus, the supply could oftentimes not meet the demand, which could diminish overall sales. With the present system, however, trends, crazes, and/or fads can be detected, and the overall sales can be predicted. Once the trends are detected and the sales predicted, the volume of items that are the subject of the trends can be increase through notification of suppliers and/or retailers. Thus, suppliers and retailers will not be at such a disadvantage as was the case prior to the detection of these trends.

### CLAIM OF PRIORITY

This application claims priority from U.S. Provisional Patent Application No. 60/777,814 entitled “METHOD AND SYSTEM FOR DETECTING AND REPORTING SALES TRENDS” filed on behalf of Paul V. Storm, on Mar. 1, 2006, which is incorporated herein by reference for all purposes.

### TECHNICAL FIELD

The invention relates generally to supply chain software and, more particularly, to predictive sales algorithms and the associated system.

### BACKGROUND

In the retail industry, crazes, fads, or other sales trends are a relatively frequent occurrence. These sales trends, however, have a tendency to catch both suppliers and retailers off-guard at every level. As a result, industries oftentimes have difficulty meeting the demand for items that are the subject of trends. To date, there are a variety of automated supply chain solutions for handling inventories. Typically, these solutions address cyclical inventory issues and streamlining the supply pipeline. Some examples of such patents are U.S. Pat. No. 6,415,195, U.S. Pat. No. 5,854,746, U.S. Pat. No. 5,946,663, U.S. Pat. No. 6,978,249, U.S. Pat. No. 5,819,232, U.S. Pat. No. 6,609,101, U.S. Pat. No. 6,032,125, and U.S. Pat. No. 6,205,431. However, there is no such solution that detects specific trends, fads, or crazes to allow the supplier and retailer to meet heavy demand.

Further, when a fad is ending, suppliers may continue producing beyond what will be salable. The difficulty of detecting fads is exacerbated by the use of multiple outlets (i.e. different retailers). Sales information from one outlet may not be shared with sales information with another outlet, making early detection of a trend or detection of the end of a trend more difficult. Thus, smaller retailers, suppliers, or wholesalers may be disadvantaged due to the lack of data available.

Therefore, there is a need for a method and/or system for detecting trends and notifying manufactures and retailers, which addresses at least some of the problems not solved by conventional solutions.

### SUMMARY

The present invention comprises a method in an electronic data processing system or a computer program for predicting. Sale events of at least one item from a plurality of merchants are aggregated. A first derivative of sales with respect to time of the at least one item over a predetermined interval of less than one month is calculated. The first derivative is compared to a first threshold rate, and if the first derivative is greater than or equal to the first threshold rate, a trend is indicated.

In another preferred embodiment of the present invention, predicted sales of the at least one item are calculated from the first derivative or rate of change of sales.

In an alternative embodiment of the present invention, a determination is made as to whether a rate at which the first derivative is changing is less than or equal to a second threshold rate. The predicted sales are recalculated, and notifying the distributor of the predicted sales.

In another preferred embodiment of the present invention, a supplier of the at least one item of the trend is notified.

In an alternative embodiment of the present invention, a second derivative of the sales of the at least one item is calculated, and a determination is made as to whether the second derivative has changed from a positive value to a negative value. The predicted sales of the at least one item from the first derivative are also calculated.

In another preferred embodiment of the present invention, the process of calculating the predicted sales is further defined. Specifically, a determination is made as to when the second derivative was approximately equal to zero, and an extrapolation as to when the first derivative will be approximately be equal to zero is made. A determination of initial sales between the time at which the first derivative was approximately equal to first threshold rate and the time at which the derivative will be approximately equal to zero is made, and the predicted sales are determined by symmetry.

In an alternative embodiment of the present invention, the at least one item is selected from the group consisting of a product and a group of products.

In another preferred embodiment of the present invention, the plurality of merchants are selected from the group consisting of retailers and wholesalers.

In an alternative embodiment of the present invention, at least one competing supplier of the at least one item of the trend is notified.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram of the system in accordance with a preferred embodiment of the present invention;

FIG. 2 is a flow chart depicting the operation of the system of FIG. 1;

FIGS. 3, 4A, 5A, 6A, and 7A are examples of line graphs for sales as a function of time in accordance with a preferred embodiment of the present invention;

FIGS. 4B, 5B, 6B, and 7B are examples of line graphs for the first derivative of the function depicted in FIGS. 4A, 5A, 6A, and 7A, respectively;

FIGS. 4C and 5C are examples of line graphs depicting linear extrapolation of the predicted sales for a detected trend; and

FIGS. 6C and 7C are examples of line graphs for the second derivative of the function depicted in FIGS. 6A and 7A, respectively.

### DETAILED DESCRIPTION

In the discussion of the FIGURES, the same reference numerals will be used throughout to refer to the same or similar components.

In the following discussion, numerous specific details are set forth to provide a thorough understanding of the present invention. In other instances, well-known elements have been illustrated in schematic or block-diagram form in order not to obscure the present invention in unnecessary detail.

It is further noted that, unless indicated otherwise, all functions described herein are performed by a processor such as a computer or electronic data processor in accordance with code such as computer program code, software, or integrated circuits that are coded to perform such functions.

The term “item” refers to a product, or a class, category, or group of products. For example, a product is a two liter bottle of Dr. Pepper®, and a category of products is carbonated soft drink.

The term “merchant” refers to a retailer, wholesaler, or any other sales entity in a typical supply chain.

The term “supplier” refers to a manufacturer, parent company, marketer, or any other entity involved in the production of an item.

The term “communication channel” refers to any type of electronic communication medium including, but not limited to, wireless, optical, or any other medium capable of supporting packet transmission. Additionally, a “communication channel” may be a virtual communication channel between software components within a computer system.

The term “engine” refers to any type of algorithm, module, subroutine, computer program code, software, or integrated circuits coded or configured to perform a predetermined function.

The term “computer network” refers to any computer network including, but not limited to, the Internet, a packet switching network, and so forth.

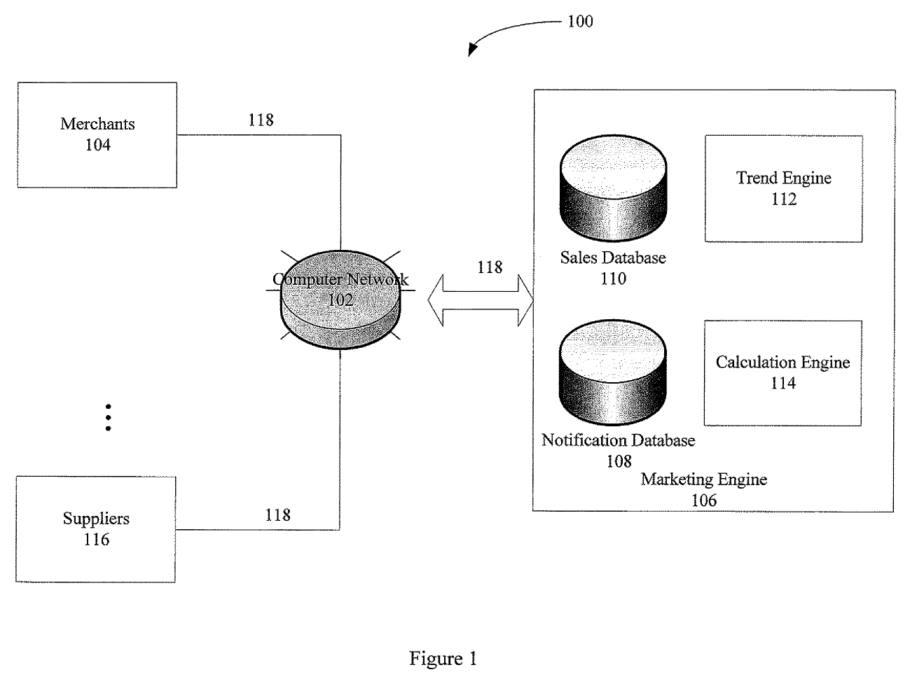

Referring to FIG. 1 of the drawings, the reference numeral 100 generally designates a system for predicting and reporting trends for sales. The system 100 comprises a computer network 102, merchants 104, suppliers 116, and a marketing engine 106.

The system 100 operates by having merchants 104 communicate data regarding sales to the marketing engine 106 and by having the marketing engine 106 communicate predictive data to suppliers 116. The communication of data between these different entities is enabled through the communication channels 118 and computer network 102. Specifically, the marketing engine 106 receives sales data from the merchants 104 and stores that sales data in a sales database 110. A trend engine 112 and a calculation engine 114 analyze the sales data and notify the appropriate suppliers and/or merchants indicated in the notification database 108.

In particular, some advantages of this system 100 are that industry-wide data can be available to smaller merchants or suppliers and that competitors may be able to better compete with one another. Because the data collected in the marketing engine 106 is based on industry-wide sales (and not a particular merchant or supplier), the smaller merchant or supplier would have access to data that would be otherwise unavailable. Thus, merchants and suppliers would neither be too overstocked nor too understocked when at times when a trend is occurring. Moreover, sales data can be very valuable to competitors because it would enable both competitors to anticipate each other's sales and trends.

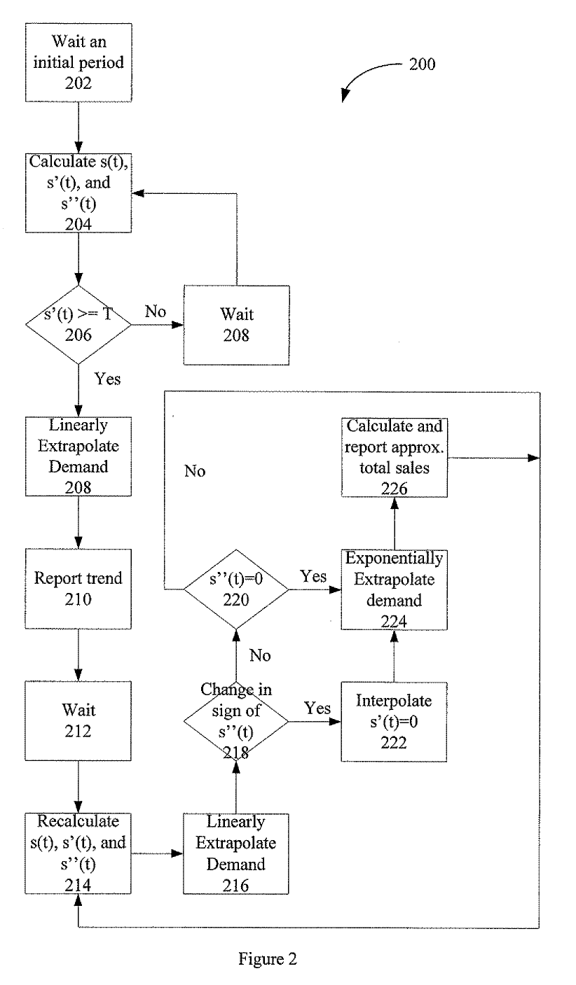

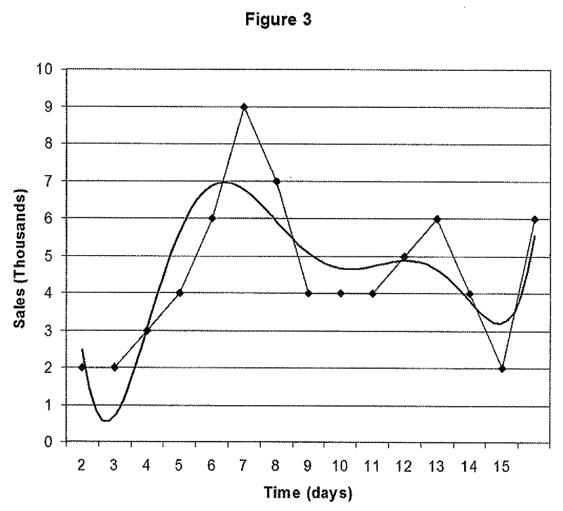

Referring to FIG. 2 of the drawings, the reference numeral 200 generally designates a flow chart of the analysis and notification performed by the marketing engine 106. Additionally, FIGS. 3-7C illustrate, by way of an example, a portion of the analysis and notification depicted in FIG. 2.

At the beginning of the sales analysis, the sales data is typically not reliable because a sufficient history of sales does not exist. Insufficient historical data can typically lead to varied and inaccurate predictions. In step 202, an initial period, accordingly, is allowed to expire before analysis begins. The length of this time period varies substantially from item to item, but the initial period can generally be determined based on the type of item. Typically, the initial period can range from a few weeks to more than one year.

For example, FIG. 3 a line graph is shown depicting sales versus time is shown, where a sixth order polynomial trend line is superimposed over the line graph. As can be seen in FIG. 3, the fluctuations are drastic. Because of theses very large fluctuations, the reliability of any trend detected would be suspect. Thus, the initial period for FIGS. 3-7C is chosen to be 10 days.

Once the initial time period has expired, calculations are performed in the sales data in step 204. In particular, derivatives and curve fits are calculated. There are a variety of extrapolation or curve fitting techniques that can be employed, such as least square regression and so forth. As shown in FIGS. 3-7C, a least square curve fit is employed using a polynomial of degree six to calculate s(t). The sixth order least curve fit polynomial has a general form, which is as follows:

(1)

where aᵢ are the polynomial coefficients. Numerically, the matrix representation is generally more useful, where the general form is as follows:

y=Ta, (2)

where y is the sales vector. Thus,

a=(T^{T}T)⁻¹T^{T}y. (3)

Once the equation for the curve has been determined, then the first and second derivatives can be calculated. Specifically, the first and second derivatives (s′(t) and s″(t), respectively) yield various characteristics of the curve, namely slopes, minimums, maximums, and points-of-inflection. Typically, the values of the first and second derivatives (s′(t) and s″(t), respectively) are not as important as the signs (positive/negative slope and positive/negative concavity) and roots (minimums, maximums, and points-of-inflection). However, in determining whether a trend is beginning, namely a fad or craze, the magnitude of the first derivative, s′(t), can be important.

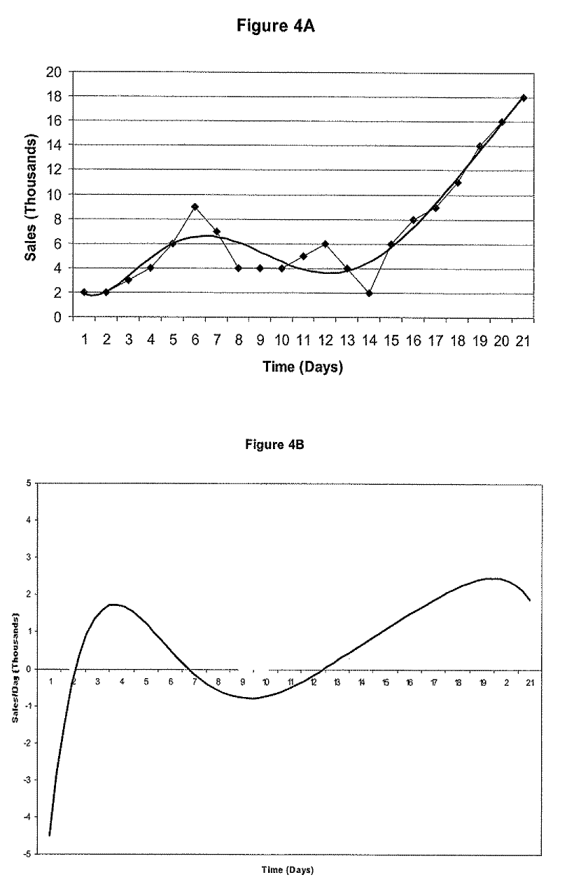

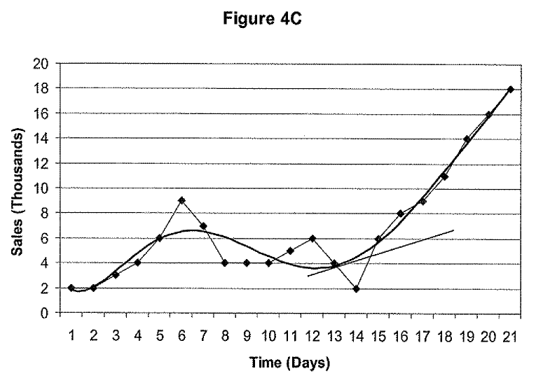

In step 206, a determination is made as to whether the magnitude of the first derivative is greater than a threshold value (T). The threshold value (T) is typically a constant determined through historical data. Reaching and/or eclipsing the threshold value (T) may be indicative of a trend. As seen in FIGS. 4A and 4B, the threshold value is chosen to be one, thus at day 15, s′(t) is greater than or equal to one. Therefore, a trend is detected at day 15.

If a trend is detected, one advantage of the present invention is that manufactures can be notified so that demand can be met. At the beginning of a trend, however, determining future demand can be very difficult. The demand, though, can be estimated through a variety of techniques, namely extrapolation techniques. In step 208, the demand is linearly extrapolated from several intervals prior to the detected trend, which is shown in FIG. 4C. Preferably, three to four intervals prior to the detected trend are used. However, the linear extrapolation is not accurate for long periods of time (periods typically not exceeding ten intervals). The prediction, therefore, is limited to several intervals following the indication of a trend.

Once the trend has been detected and the demand has been predicted, the trend is reported in step 210. Depending on the party monitoring the sales, there are a number of suppliers that can be notified. Specifically, an entire sector of suppliers or individual suppliers, including competing suppliers, can be notified. Additionally, merchants can be notified, so that more orders can be placed. After the trend is reported, a predetermined time period is allowed to expire in step 212. Preferably, this time period is no greater than the length of the prediction.

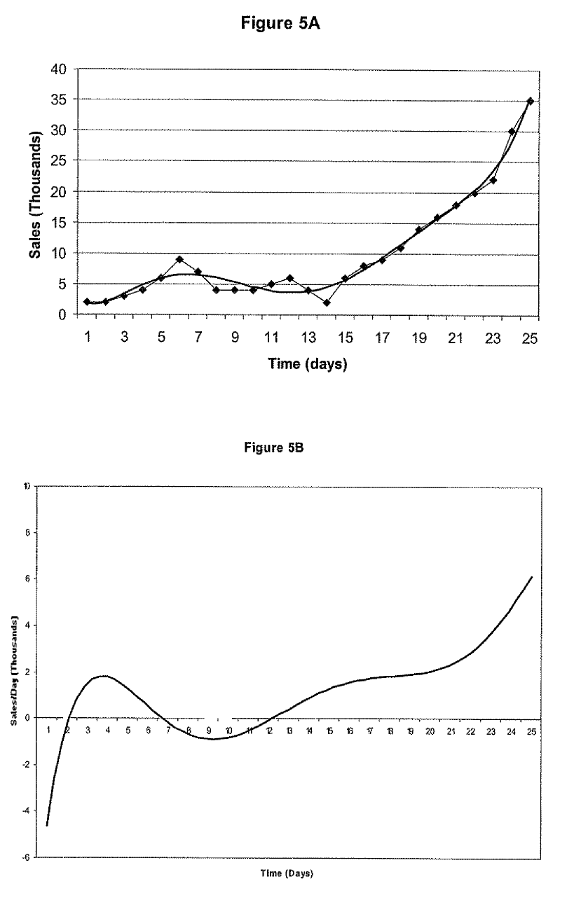

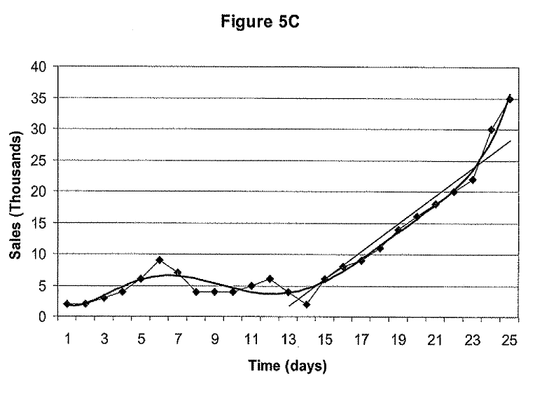

After the time period in step 212 is allowed to expire, s(t), s′(t), and s″(t) are recalculated in step 214. As can be seen in FIG. 5A, the demand actually exceeded the predicted demand. Once recalculated, the demand is again linearly extrapolated in step 216, which is shown in FIG. 5C. Additionally, a recalculated s′(t) is shown in FIG. 5B.

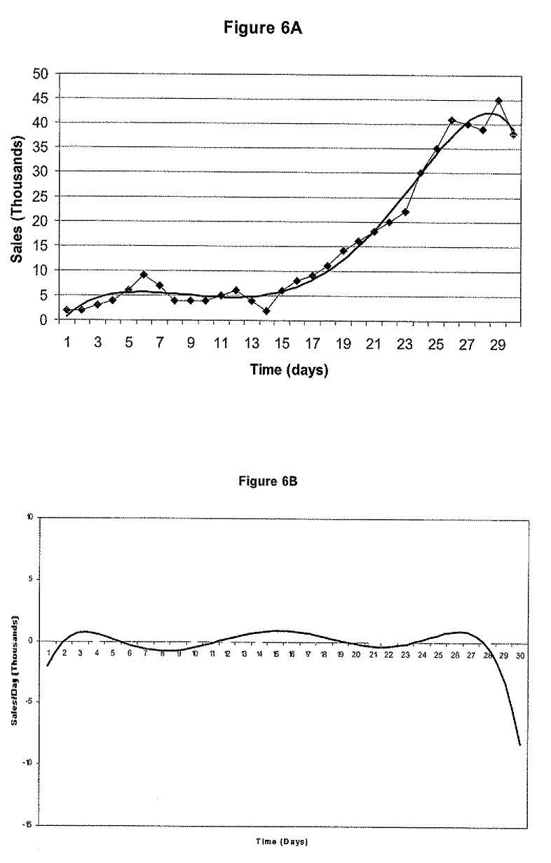

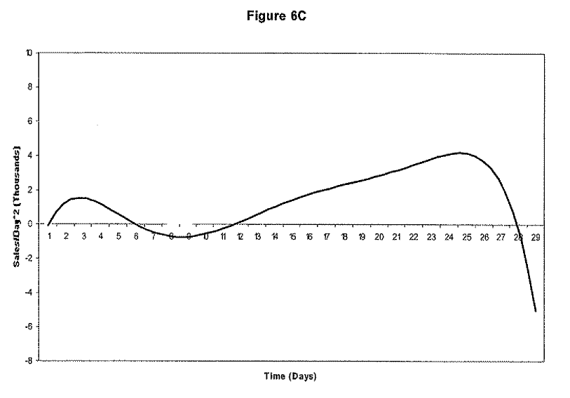

Once re-extrapolated, a determination is made as to if a change in sign of s″(t) has occurred in step 218. A change in sign typically indicates that a point-of-inflection or change in concavity has occurred. This change in concavity indicates that the trend may be fading. As can be seen in FIGS. 6A-6C, s(t), s′(t), and s″(t) are shown, which indicate both changes in concavity and minimums/maximums. If a change in sign of s″(t) has occurred, then an interpolation technique is employed to determine the time at which s″(t) equaled zero in step 222. Alternatively, in the case where, a change is sign of s″(t) is not detected, a determination is made as to if s″(t) is equal to zero, in step 220.

Based on the point-of-inflection determined in either step 220 or 222, a more accurate curve may be employed to calculate future sales. Specifically, an exponential extrapolation employing a bell curve is used in step 224. One reason for use of a bell curve is that it is assumed that for fads or other temporary crazes the sales as a function of time approximately resemble a symmetric bell curve. A variety of other symmetric curves can also be used to extrapolate future sales. The general form of exponential function used to model and predict sales is as follows:

f(x)=exp [−(x−μ)²/σ²], (4)

where μ is the time of maximum sales and σ is the width of the curve or the time between the point-of-inflection and μ. Based on the exponential curve that approximates the predicted curve calculated, then the total sales can be calculated and reported in step 226. Recalculation can then occur in step 214 to insure that the predictions are accurate. Alternatively, if no determination of a change of sign or root of s″(t) can be made in step 220, then a recalculation can also reoccur in step 214, beginning the process over again.

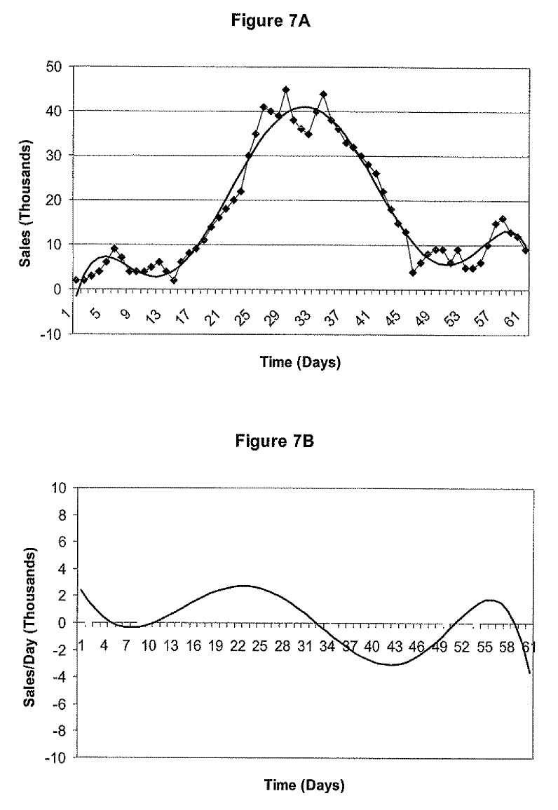

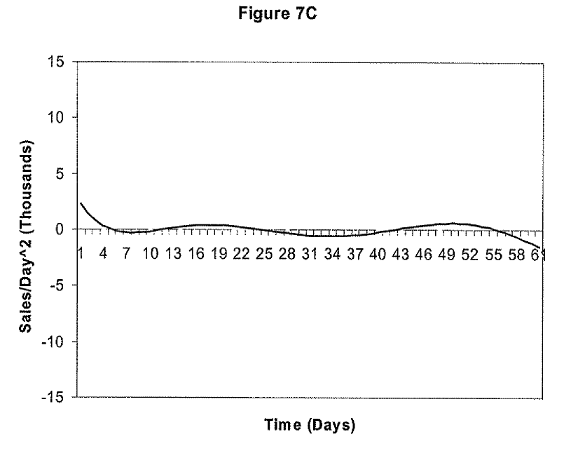

Turning to FIGS. 7A-7C, the symmetry of the sales trend can be seen after the sales trend has run its course. Thus, the system 100 would be able to roughly predict total sales so that supply could at least approximate demand. As can be seen, however, the sales are generally predictable. Because the sales are effectively a random walk, the system 100 is not without error or fault, which is true with any predictive system or algorithm.

Thus, the system 100 detects specific trends, fads, or crazes to allow the supplier and retailer to meet heavy demand, even for the smaller merchants or suppliers due to access to industry-wide data. The detection of the end of trends also allows suppliers to reduce production so that an overstocks will be reduced. Therefore, the system 100 allows merchants and suppliers to better streamline their respective operations, reduce losses, and be more competitive irrespective of size.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A prediction method in an electronic data processing system, comprising:
aggregating sale events of at least one item from a plurality of merchants;
calculating a first derivative of sales with respect to time of the at least one item over a predetermined interval of less than one month;
comparing the first derivative to a first threshold rate; and
if the first derivative is greater than or equal to the first threshold rate, indicating a trend.

2. The method of claim 1, wherein the method further comprises calculating predicted sales of the at least one item from the first derivative of sales.

3. The method of claim 2, wherein the method further comprises:
after the first derivative has been determined to be greater than or equal to the first threshold rate, determining if a rate at which the first derivative is changing is less than or equal to a second threshold rate;
recalculating the predicted sales; and
notifying the distributor of the predicted sales.

4. The method of claim 1, wherein the method further comprises notifying a supplier of the at least one item of the trend.

5. The method of claim 1, wherein the method further comprises:
calculating a second derivative of the sales of the at least one item;
determining if the second derivative has changed from a positive value to a negative value; and
calculating the predicted sales of the at least one item from the first derivative.

6. The method of claim 5, wherein the step of calculating the predicted sales further comprises:
calculating when the second derivative was approximately equal to zero;
extrapolating when the first derivative will be approximately be equal to zero;
determining initial sales between the time at which the first derivative was approximately equal to first threshold rate and the time at which the derivative will be approximately equal to zero; and
determining the predicted sales by symmetry.

7. The method of claim 1, wherein the at least one items is selected from the group consisting of a product and a groups of products.

8. The method of claim 1, wherein the merchants are selected from the group consisting of retailers and wholesalers.

9. The method of claim 1, wherein the method further comprises notifying at least one competing supplier of the at least one item of the trend.

10. A processor with a computer program for predicting embodied thereon, the computer program comprising:
computer code for aggregating sale events of at least one item from a plurality of merchants;
computer code for calculating a first derivative of sales with respect to time of the at least one item over a predetermined interval of less than one month;
computer code for comparing the first derivative to a first threshold rate; and
if the first derivative is greater than or equal to the first threshold rate, computer code for indicating a trend.

11. The computer program of claim 10, wherein the computer program further comprises computer code for calculating predicted sales of the at least one item from the first derivative of sales.

12. The computer program of claim 11, wherein the computer program further comprises:
after the first derivative has been determined to be greater than or equal to the first threshold rate, computer code for determining if a rate at which the first derivative is changing is less than or equal to a second threshold rate;
computer code for recalculating the predicted sales; and
computer code for notifying the distributor of the predicted sales.

13. The computer program of claim 10, wherein the computer program further comprises computer code for notifying a supplier of the at least one item of the trend.

14. The computer program of claim 10, wherein the computer program further comprises:
computer code for calculating a second derivative of the sales of the at least one item;
computer code for determining if second derivative has changed from a positive value to a negative value; and
computer code for calculating the predicted sales of the at least one item from the first derivative.

15. The computer program of claim 14, wherein the step of calculating the predicted sales further comprises:
computer code for calculating when the second derivative was approximately equal to zero;
computer code for extrapolating when the first derivative will be approximately be equal to zero;
computer code for determining initial sales between the time at which the first derivative was approximately equal to first threshold rate and the time at which the derivative will be approximately equal to zero; and
computer code for determining the predicted sales by symmetry.

16. The computer program of claim 10, wherein the at least one items is selected from the group consisting of a product and a groups of products.

17. The computer program of claim 10, wherein the merchants are selected from the group consisting of retailers and wholesalers.

18. The computer program of claim 10, wherein the computer program further comprises computer code for notifying at least one competing supplier of the at least one item of the trend.
